(19) United States
(12) Patent Application Publication
(10) Pub. No.: US 2014/0164105 A1
(43) Pub. Date: Jun. 12, 2014

(54) method for the controlled display of information banners, in particular advertising banners, on the internet

(71) Applicants: Daniele Pisanelli, Carrara (MS) (IT); Luca Pisanelli, Carrara (MS) (IT)

(72) Inventors: Daniele Pisanelli, Carrara (MS) (IT); Luca Pisanelli, Carrara (MS) (IT)

(21) Appl. No.: 14/122,590

(22) PCT Filed: Jun. 3, 2011
(86) PCT No.: PCT/IT2011/000186

§ 371 Date: Feb. 24, 2014

(51) Int. Cl. G06Q 30/02

(52) U.S. Cl. CPC G06Q 30/0251; G06Q 30/0277
USPC 705/14.49

(57) ABSTRACT

An innovative method for the display of one or more pieces of information on the Web, particularly advertising, includes the steps of:
a) Connecting, through the Internet, a processor to a central server;
b) Monitoring, through a sentinel programme, possible connection made by the processor to one or more remote servers for operating the download of one or more applications;
c) In case of download of an application, sending from the central server to the processor, through the Web, one or more information banners that overlap the banner of the requested download;
d) Computing the number of sendings, so as to associate credits to the user on the basis of the received advertising displays.

### TECHNICAL FIELD

The present invention refers to the technical field relative to advertising on the Internet.

In particular, the invention refers to a particular application that allows to display information banners, in particular advertising ones, for a pre-established time-period, every time any kind of download operation starts, for example of a software or of an application.

### BACKGROUND ART

Various applications on the Internet through which information of any kind is displayed have long been known, in particular the common commercial advertising. For example, Web browsers such as “Google” or Web sites like “Yahoo” are nowadays used, which display the news of the day and information of any kind, as well as advertising. In addition, by simply selecting with the computer mouse the advertising banner, it is also possible to surf the Web pages through connections to the specific Web pages. In this way, in the case of news, it is possible to read more about them, while in the case of advertising, it is possible to obtain further information on the product.

However, currently, the number of users that requests the insertion of information on Web sites is always growing. Accordingly, the waiting time for the insertion of the own banner, advertising one or of any other kind, is always greater and costs are always higher.

### BRIEF DESCRIPTION OF THE INVENTION

It is therefore the aim of the present invention to give an innovative information method, in particular advertising, that solves at least in part said drawbacks.

In particular, it is the aim of the present invention to give an innovative display method of information on the Web, in particular of advertising information, that allows the wider, more efficient and above all economical spread of information.

Moreover, it is the aim of the present invention to give an innovative display method of information on the Web that allows to knock down the current waiting time to have access to, and therefore use, an advertising service on the Web.

These and other aims are therefore reached with the present display method of information on the Web, preferably the Internet, according to claim 1.

The present method includes the following operations of:

a) Connection, through the Web, of a processor (3) to a central server (1) and
b) Monitoring of the eventual downloads of one or more applications (25) requested by a user (3) (through his own processor 3) towards one or more remote servers (10) to which the user connects to the Web, preferably on the Internet.

During such monitoring, as soon as a download request of an application (25) made by the user is identified, a further phase c) of sending of one or more information banners (15), from the central server (1) to the processor (3), is included always through the Web.

In this way, each transfer of information becomes very efficient and widespread since said information is received at the very moment each download request is made by the client.

Such information can be of any kind and can also comprise further information on the programme that is being downloaded.

All the users that wish to present on the Web information of any kind, for example advertising, have now a new efficient transmission channel, benefiting on the whole from a reduction of costs to access such service and a reduction of the waiting time.

Advantageously, a phase d) can be further included of computation of the information banners (15) sent to the processor (3) so as to prearrange a credit for the user associated to the processor (3) when the pre-established minimum limit is reached.

Such a phase d) is very advantageous since, in fact, prompts each user to receive information which, above all in the case of advertising, is often considered undesired.

In this way, a system of information spread, in particular of advertising, is created, which can result really efficient.

Advantageously, in a possible embodiment, the monitoring in the phase b) can be implemented through a sentinel programme (35) installed in the processor (3) of each “client” and which detects a download request activated from the processor (3) towards a remote server (10).

In fact, the installation in the processor (3) of the application that implements the method described here includes the installation of such sentinel programme, which controls the connection to the remote servers (10) and, when an application is downloaded, it informs the server (1) with which the application has made the network connection.

Advantageously, the connection in the phase a) and in the phase c) is operated on the Internet.

Advantageously, the phase c) includes the overlapping of said one or more information banners (15) on the banner (25) of the requested download.

This is possible because said application that is installed in the processor (3) of each client (3), apart from having a sentinel function, modifies the banner (25) of the application that is downloaded to be able to apply to it the advertising banner (15) sent from the central server (1) to the specific client.

Said computation in the phase d) can be operated by the server (1) for each download request detected.

Advantageously, in a first possible solution, the computation can include a calculation of the number of information banners sent to each user and on the basis of it, the credit to be associated to the user can be calculated.

Advantageously, alternatively, the computation can include a calculation of the display time of the banner (15) displayed and on the basis of it, a calculation of the credit to be associated to the user.

In a third possibility, advantageously, the computation can include a combination of calculation of the display time of the banner (15) with the overall number of banners sent and on the basis of it, a calculation of the credit to be associated to the user.

Advantageously, before said phase a) a preliminary phase of first access to the service is included and that comprises the registration to the service furnished by said server (1).

For example, the specific application can be downloaded in the own processor launching it for the first time for making a registration and activating it every time it is wished by inserting the own access credentials.

Accordingly, advantageously, the phase of first access comprises the sending through the Internet to the server (1) of one or more user identification data (3) and the reception of one or more access data (6).

The application connects, through Internet, the server (1) to the client (3) connected, who can send his access data and create his own account.

Subsequently, every time the user requests the access by activating the application and inserting his own data, the server sends the advertising banners as described in correspondence of each application download.

Advantageously, in case of disconnection from the server (1), the server (1) memorizes the credits acquired by the user (3).

Advantageously, in case of reaching a pre-established minimum limit of credits, the server (1) prearranges a credit bonus for the relative user (3).

It is also described here a programme for electronic processor comprising one or more computer codes suitable for executing one or more phases of the method described, when the programme itself runs in an electronic processor.

It is also described here a computer programme characterized in that it is incorporated in a computer support.

Last, it is described here a computer characterized in that it includes a software as described.

### BRIEF DESCRIPTION OF THE DRAWINGS

Further characteristics and advantages of the present method, according to the invention, will result clearer with the description that follows of one of its embodiments, made to illustrate but not to limit, with reference to the annexed drawings, wherein:

FIG. 1 shows a connection of the server 1 to the various users 3 (called “clients”) through the Internet 2;

FIG. 2 shows schematically a Web page 4 activated by the server 1 on each user 3, or client 3, and through which the data to have access to the service according to the method described can be inserted;

FIG. 3 shows schematically the sending of the data 5 inserted by the users to the server 1;

FIG. 4 shows the processing of such data for generating an access code to the service for each user 3;

FIG. 5 shows, following the activation of the service, the monitoring carried out by the server 1 with respect of the specific client so as to send and apply the advertising banners to the banners downloaded by the user 3;

FIG. 6 shows an example of advertising banner applied to a common banner 25 of an application downloaded by the user 3.

FIG. 7 shows a flow chart according to the present method;

FIG. 8 shows a possible solution in which the server can monitor and detect the request of a client 3 for downloading an application.

### DESCRIPTION OF SOME PREFERRED EMBODIMENTS

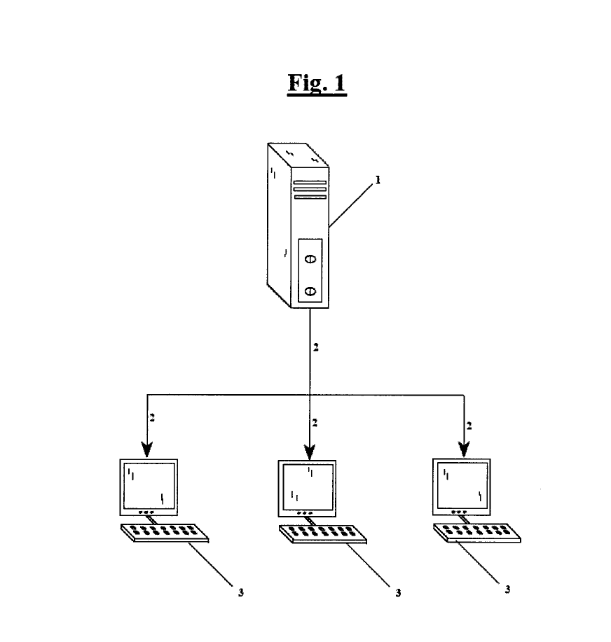

With reference to FIG. 1, a central server 1 is shown schematically which is accessible, through the Internet 2, to any number of users 3 with the use of a common processor, such as a personal computer 3. FIG. 1 shows the server 1 in communication with one or more of said personal computers.

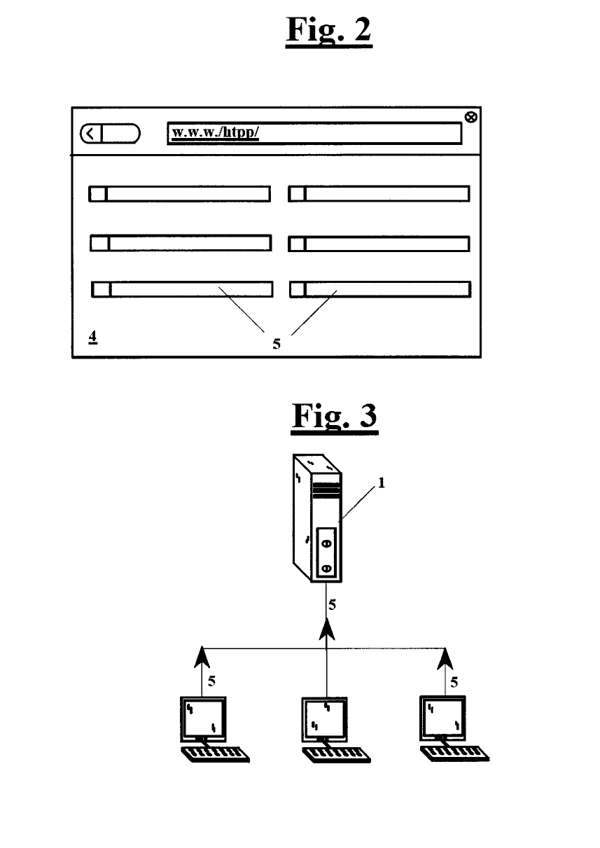

As shown in FIG. 2, each user 3 can access the service of the server 1, therefore he can actually connect to the server 1 by operating a common Internet connection to a pre-established address. In this way, once such a connection is made, the server 1 controls in the specific processor 3 the opening of a first Web page 4 through which the user 3 is placed in communication with the central server 1 itself. Through said Web page 4 the user has the possibility of forwarding one or more identification data to allow his own registration to the service and the subsequent accesses to the service. To that aim, FIG. 2 shows schematically the opening of the page 4 and displays various fields 5, each one of which requests identification data of the user. The data can be various, such as personal data and/or the personal e-mail address.

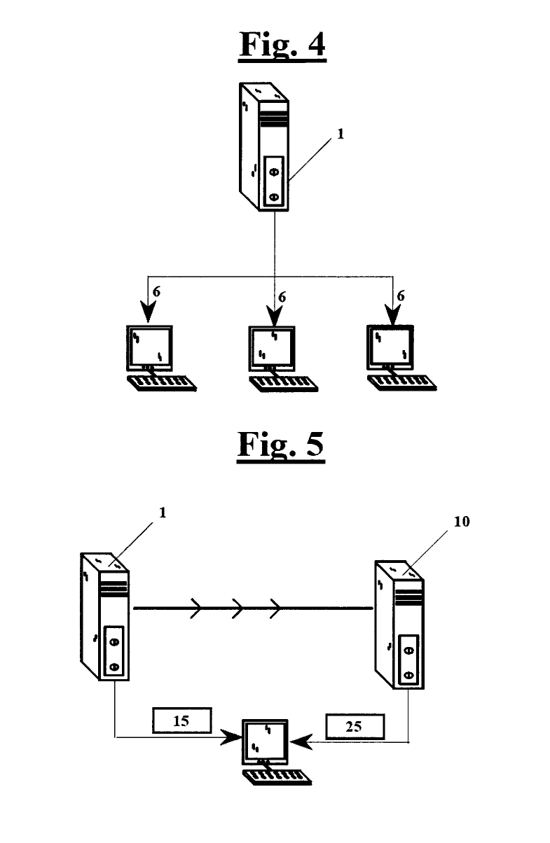

The data inserted, as schematically shown in FIG. 3 and FIG. 4, are therefore acquired by the server 1, which processes them for generating an access code 6 to the service for each user 3 (for example a password and/or a User ID). In particular, FIG. 3 shows the sending of said data 5 from each client 3 to the server, schematizing such sending through a connection line.

Likewise, FIG. 4 shows the restitution of an access code 6 from the server 1 to the client 3 following the processing of the data received from the server 1.

“Password” and/or “User ID” can be forwarded from the server to each user, for example through the sending to the mail corresponding to the personal e-mail address inserted at the time of registration.

Alternatively, the user can choose one or more access codes at the time of registration.

Such application type can be directly installed in each personal computer 3 and, once started, allows the user its activation only after the insertion of the personal access codes 6.

In particular, the application physically creates the connection to the server 1 through the Internet for each user that starts it, once an access credential has been inserted.

In any case, the user can now access to the service furnished by the server 1 at any time by simply connecting to it through the Internet and inserting his own access codes.

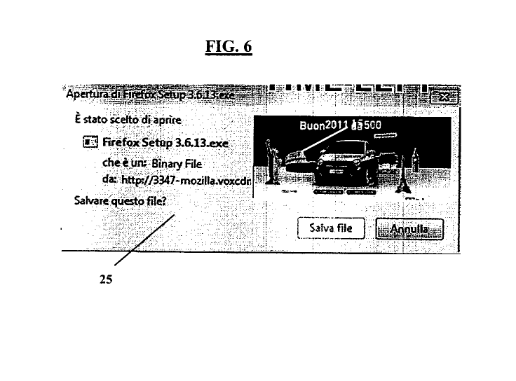

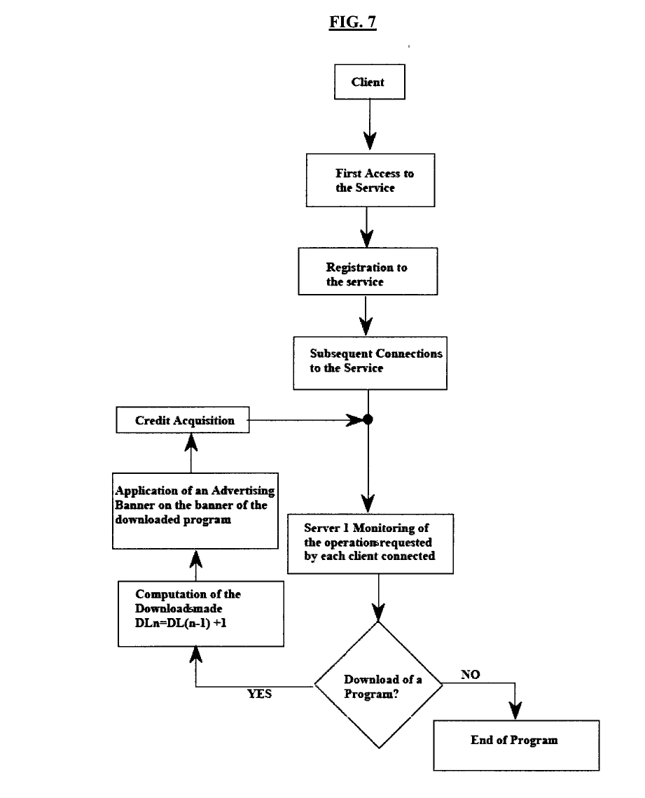

As shown schematically in FIG. 5 and in FIG. 6, the access to the service (or the connection to the server 1 through the insertion of the access codes 6 of the user 3) allows the user, every time he downloads any programme, to find the banner 25 (identificative of the programme in download phase) populated by one or more banners 15, advertising ones or general information ones.

In particular, as shown in FIG. 5, every time the service is activated, the server 1 monitors the operations requested by the client 3 to the other eventual remote servers 10 to which the client connects so that, in correspondence of a “download” request of any kind of application or programme, the server 1 is capable of sending advertising banners, which overlap the download banner 25 of the requested programme.

Just for clarification purposes, FIG. 6 shows a normal banner 25 received by the user from a remote server 10 which, however, is furnished with advertising information 15 given by the server 1 and which, on top of that, is surfable on the Internet. Accordingly, by simply positioning the computer mouse on the information screen 15 the opening of the further Web page(s) specific of such advertised product and connected to said advertising banner 15 can be controlled.

The advertising banner 15 can remain visible for a pre-established period of time.

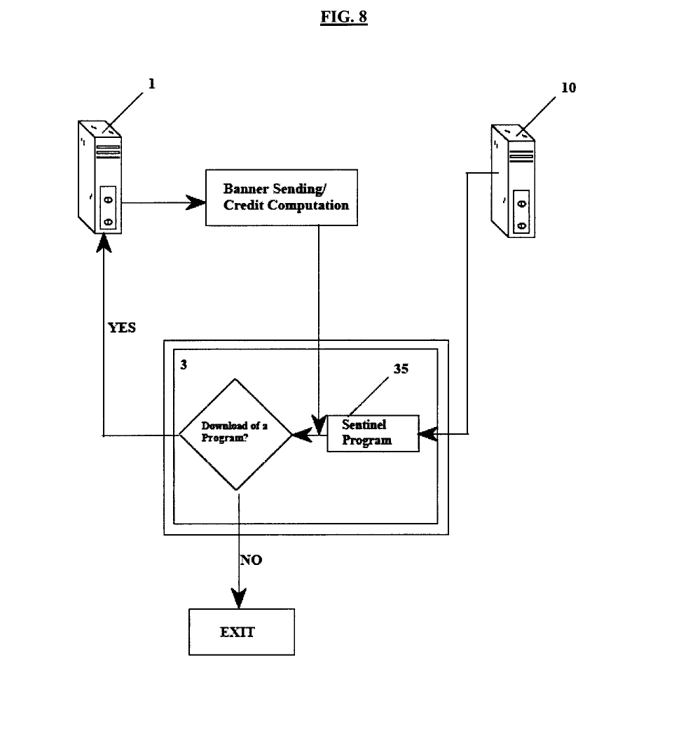

For each download operation, the server operates the sending of one or more advertising banners which overlap with the download banner. In addition, there is a computation of the downloads made which is then converted into credits or bonus. In particular, the server 1, as schematically shown in the flow chart of FIG. 7, increases by one the overall DL computation of downloads every time it, detects that a user has requested the download of an application.

In this way, for each user profile the server 1 memorizes the number and eventually also the overall display time of the advertising, increasing said computation for each subsequent download.

It is therefore possible to include a minimum limit over which the user has the right to a benefit, for example an economic benefit and/or a consumer good. In this way, the user is prompted to display the advertising.

Although the invention is based on the application of advertising banners, it is evident that it can also extend to information banners in general.

The user can disconnect from the server 1 at any time, therefore exiting from the specific application.

The flow chart of FIG. 7 sums up the most significant phases of the method described.

As shown in FIG. 8, a possible method with which the server 1 is capable of monitoring the download requests of the client 3 can be easily implemented in the following way.

It is possible to include the installation of a specific software pack 35 (defined per simplicity purposes sentinel programme 35) “client side” that communicates in background with the main server 1 when the user is connected to the Internet with said server 1.

The sentinel programme is therefore included in the application installed in the computer of the user and, as said, the user starts it every time he wishes to receive advertising.

The software is capable of detecting the connection of the user with a further remote server 10 from which it requests the download of an application, and at the same time informing the server 1 of such request and to which it results placed in communication always through the Internet. In this way, the server 1, informed by the sentinel programme of a download operation of an application from the remote server 10, sends said advertising banners directly to the client 3.

Apart from the simple installation pack for the PC of the user, the application could be thought also as an extension or plug-in of the browser itself (Firefox or Internet Explorer).

The banners 15 are downloaded periodically on the client 3 every time the download window 25 is activated. The programme that runs on client (always the same application that is installed) manages also the download window, modifying it so as to be able to apply to it the advertising banner 15 sent by the central server 1 to the client connected.

The server 1, further, carries out a computation of the number of displays acquired by the sponsor for each single banner, at the end of which the banner will no more be visible. If more sponsors and more banners are ready for download, which is hoped, they will be displayed in rotation on the client on the basis of a function that takes into consideration the priority right, assigning a position order from 1 to 100 and differentiating the pay per impression on the basis of the order of display of the banners.

This last specification does not concern the user and the application client side.

The invention claimed is:

1. A method of advertising on the internet comprising the steps of:
a) connecting, through the internet, a processor (3) to a central server (1);
b) monitoring possible downloads of one or more applications (25) requested by the processor (3) to one or more remote servers (10) connected to the internet; and
c) in case of download of an application (25), sending from the central server (1) to the processor (3), through the internet, one or more advertising banners (15),
wherein the step of monitoring comprises providing a sentinel program (35) configured to detect a download request from the processor (3) to a remote server (10), the sentinel program (35) communicating in background with the central server (1) when a user is connected to the internet through the processor (3), and
wherein, after the sentinel program (35) detects a connection of the user with the remote server (10) to request a download of an application, the sentinel program (35) informs the central server (1) of such request such that the server (1), informed by the sentinel program (35) of a download operation of an application from the remote server (10), sends said one or more advertising banners directly to the processor (3).

2. The method, according to claim 1, further comprising the step of computing a number of the advertising banners (15) sent to the processor (3), so as to prearrange a credit to the user associated with the processor (3) when a pre-established minimum limit is reached.

3-4. (canceled)

5. The method, according to claim 1, wherein step c) includes the step of overlapping said one or more advertising banners (15) on a banner (25) of the requested download.

6. The method, according to claim 2, wherein the step of computing is performed by the central server (1) for each detected download request.

7. The method, according to claim 2, wherein the step of computing comprises calculating a credit associated with the user based on the number of said advertising banners sent to the user.

8. The method, according to claim 2, wherein the step of computing comprises calculating a display time of the advertising banners (15) displayed and, based on said display time, calculating a credit to be associated with the user.

9. The method, according to claim 2, wherein the step of computing comprises a combination of calculating a display time of the advertising banners (15) displayed with an overall number of the advertising banners sent and, based on said display time, calculating a credit to be associated with the user.

10. The method, according to claim 1, wherein before said step a), a preliminary step of first access to the service is included, said preliminary step comprises the step of registering to the service furnished by said central server (1).

11. The method, according to claim 10, wherein said step of first access comprises sending through the internet to the central server (1) one or more user identification data (3) and receiving one or more access data (6).

12. The method, according to claim 1, wherein, in case of disconnection from the central server (1), the central server (1) memorizes the credit acquired by the user (3).

13. The method, according to claim 1, wherein, in case of reaching a pre-established minimum limit of credits, the centra; server (1) prearranges a credit bonus for the user (3).

14. A program for an electronic processor comprising:
one or more computer codes configured to execute one or more phases of the method according to claim 1,
when the program runs in an electronic processor.

15. The method according to claim 8, further comprising the step of providing a computer support.

16. A computer comprising:
an electronic processor having a program according to claim 14 loaded therein.

17. The method, according to claim 1, wherein the sentinel program (35) is installed in the processor (3) or is an extension of an internet browser.
